(19) United States
(12) Patent Application Publication
(10) Pub. No.: US 2023/0289658 A1
(43) Pub. Date: Sep. 14, 2023

(54) INCREMENTAL MACHINE LEARNING TRAINING

(71) Applicant: Home Depot Product Authority, LLC, Atlanta, GA (US)

(72) Inventors: Ying Xie, Marietta, GA (US); Tejaswini Mallavarapu, Dunwoody, GA (US); Simon Hughes, Atlanta, GA (US)

(21) Appl. No.: 18/097,070

(22) Filed: Jan. 13, 2023

Related U.S. Application Data
(60) Provisional application No. 63/299,830, filed on Jan. 14, 2022.

(51) Int. Cl. G06N 20/00

(52) U.S. Cl. CPC G06N 20/00

(57) ABSTRACT

A method for training a machine learning model includes receiving a randomly-initialized first version of a machine learning model, conducting first training on the machine learning model first version using first training data, the first training data comprising a first type of information respective of a plurality of documents, adding a layer to the machine learning model first version after conducting the first training to create a machine learning model second version, and conducting second training on the machine learning model second version using second training data, the second training data comprising a second type of information respective of the plurality of documents.

### FIELD OF THE DISCLOSURE

The present disclosure generally relates to training a machine learning model, including an incremental approach to machine learning training.

### BRIEF DESCRIPTION OF THE DRAWINGS

FIG. 1 is a block diagram illustrating an example system for training and deploying a machine learning model.

FIG. 2 is a flow chart illustrating an example method of training and deploying a machine learning model.

FIG. 3 is a flow chart illustrating an example method of training a machine learning model.

FIG. 4 is a diagrammatic view of the method of FIG. 3.

FIG. 5 is a diagrammatic view of an example user computing environment.

### DETAILED DESCRIPTION

Current techniques for training machine learning models for natural language processing generally include first training a blank model with a large amount of text from public text repositories. End users of such models may conduct additional training specific to their domain, but the initial pre-training of the model results in a non-ideal recognition by the models of domain-specific language because the vocabulary and language structures used in a specific domain, such as a product catalog, may be quite different from general language that a pre-trained model was trained upon. For example, product catalog text often does not have a sentence structure. Instead, it may contain multiple sections of product attributes, which are likely phrases or single words. As another example, a product title may be a long phrase that includes multiple consecutive adjectives and/or numeric dimensions. Further, the vocabulary used in a product catalog is much more restricted than general language. In other domains, other differences may exist relative to general language that similarly

The instant disclosure improves upon known training approaches for natural language processing machine learning models by starting from a blank model, conducting a first training round using high-level domain-specific information, such as documents titles, and then conducting second and further training rounds in which additional domain-specific information is incorporated into the training process. In some embodiments, additional layers are added to the model in the second and further training rounds.

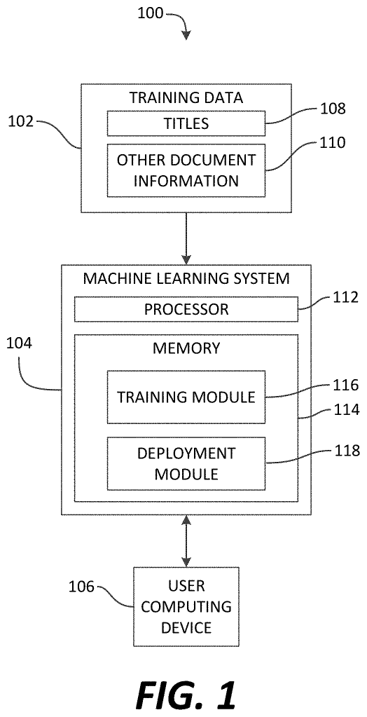

Referring to the drawings, wherein like numerals refer to the same or similar features in the various views, FIG. 1 is a block diagram illustrating an example system 100 for training and deploying a machine learning model. The system 100 may include a set of training data 102, a machine learning system 104, and a user computing device 106.

The training data 102 may include a plurality of document titles 108 and a plurality of other document information 110. The documents that are the subject of the training data may be documents accessible through a particular electronic user interface, such as a website or application. The titles 108 and other information 110 of the documents may be respective of the documents themselves, or may be respective of the subjects of the documents. For example, in some embodiments, each document may be a page respective of a product or service available through the electronic user interface, and thus the titles and other information may be respective of products and services. The other document information 110 may include, for example, the placement of the document (or subject of the document) in a taxonomy respective of the electronic interface, such as a product taxonomy. The other document information may additionally or alternatively include, for example, a brand of a product or service. Still further, the other document information 110 may include images associated with a subject of the document, user sentiment (e.g., reviews or ratings) associated with the document or subject of the document, one or more features of the document and/or subject of the document.

The machine learning system 104 may include a processor 112 and a non-transitory, computer readable memory 114 storing instructions that, when executed by the processor 112, cause the processor 112 (and therefore the system 104) to perform one or more processes, methods, operations, algorithms, steps, etc. of this disclosure. For example, the memory may include a training module 116 configured to train a machine learning model and a deployment module 118 configured to implement the trained machine learning model.

The training module 116 may be configured to train the machine learning model using the training data 102 to make one or more predictions respective of the documents available through the electronic user interface. For example, the training module may train a randomly-initialized model to classify one or more of a taxonomy of a document (e.g., a classification within one or more levels of a hierarchical taxonomy), one or more features of a document or a subject of the document, one or more image features of the document or a subject of the document, one or more aspects of user sentiment regarding a document or a subject of a document, or other information respective of the document or subject of the document.

The trained machine learning model may be deployed in many different contexts. For example, in one context, the machine learning model may be trained to score the responsive of documents to a user search query, and the trained model may be deployed to sort and arrange search engine results. In another example, the trained machine learning model may be trained to generate images from user-entered text.

The trained machine learning model may be deployed in connection with the same domain that was the source of the training data 102, in some embodiments. For example, documents that are accessible through a given website or other electronic user interface may be used by the training module 116, and the trained machine learning model may be deployed in connection with the same website or other electronic user interface.

Training and deploying a machine learning model according to the present disclosure offers numerous advantages over known methods of training and deploying machine learning models. First, known approaches for particular model types, such as bidirectional encoder representation from transformer models, generally include using a model that is pretrained on a large generic dataset. Even with domain-specific training on the generically-trained initial model, the model does not optimally adapt to the domain of deployment because of the initial generic training. In contrast, starting with a randomly-initialized model and then training only on domain-specific data, as disclosed herein, results in superior model performance. Second, adding further classification layers to the model during training, as disclosed herein, results in a training process and a model that is easily and highly adaptable to classification of many different types of information, and to many different quantities of classifications (e.g., classifying within two types of information, three types of information, etc.). Third, a model according to the present disclosure is highly adaptable to different deployment scenarios, because it can be used to output predictions for many different information types.

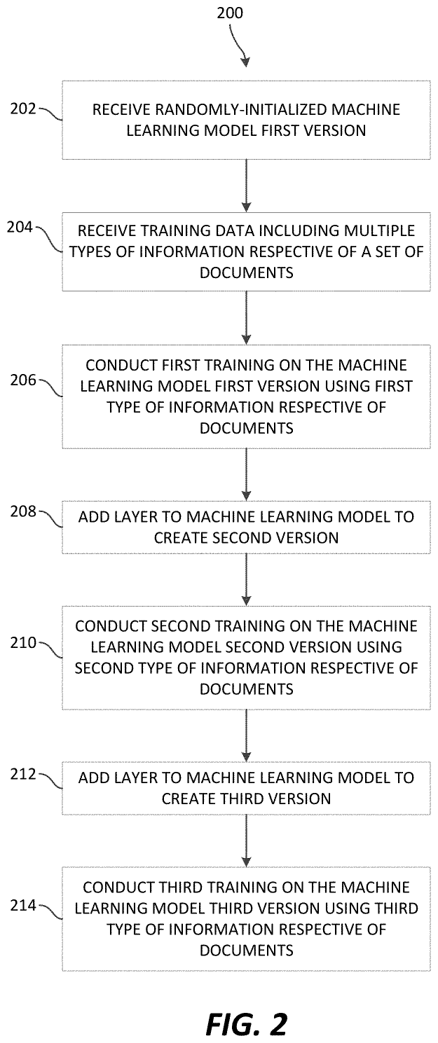

FIG. 2 is a flow chart illustrating an example method 300 of training and deploying a machine learning model. One or more portions of the method 300 may be performed by the machine learning system 104, in some embodiments.

The method 200 may include, at block 202, receiving a randomly-initialized machine learning model, which randomly-initialized model may be referred to in this method 200 as the method first version. The model may include, for example, a deep neural network that uses multi-directional bidirectional transformer encoders. In some embodiments, block 202 may include receiving a non-initialized model and randomly initializing the model.

The method 200 may further include, at block 204, receiving training data that includes multiple types of information respective of a set of documents. The set of documents may be, for example, pages for a website. In some embodiments, the set of documents may be product information pages respective of a website in which information regarding products and services may be provide, with each product information page respective of a single product or service. Accordingly, the training data received at block 204 may include multiple types of information respective of each product or service.

The multiple types of information included in the training data received at block 204 may include, for example, a title, brand, taxonomy (e.g., one or more levels of a taxonomy that may include a plurality of hierarchical levels), one or more features (e.g., color, shape, size, functional features, etc.), and/or one or more other types of information respective of a product, service, or other document. As will be described below, the method 200 may include training the model to predict one or more types of the information (e.g., a plurality of types of information) given a single type of information, all of which types of information are respective of a given set of documents.

The training data may be specific to an intended domain in which the model, once trained, will be deployed. For example, in embodiments in which the model will be deployed in association with an electronic user interface through which a user accesses a specific set of documents, the training data may be the set of documents, or a subset of the set of documents (e.g., information respective of those documents).

The method 200 may further include, at block 206, conducting first training on the machine learning model first version using a first type of information respective of the documents. The first type of information may be, for example, a title of the document or other textual descriptive information respective of the document. The training at block 206 may include masked language modelling, in which a multi-token input word or sentence is provided to the model, with one or more tokens masked, and the model predicts the complete word or phrase. The training at block 206 may teach the model the vocabulary of the intended domain of the model.

The method 200 may further include, at block 208, adding a layer to the model first version to create a model second version. The added layer may be a classification layer added to the output of the model first version, for example. The added layer may be a fully-connected layer, in some embodiments.

The method 200 may further include, at block 210, conducting second training on the machine learning model second version using a second type of information respective of the documents. The second type of information may be, for example, a first classification of the document or of the subject of the document, such as a brand of a product that is the subject of the document. The training at block 210 may include classification training, in which a first type of information is provided to the model (e.g., document title), and the model predicts the classification within the second type of information. For example, the model may receive a product or other document title and may predict a brand of the product. The training at block 210 may enable the model to predict the classification of a document within the second type of information.

Training at block 210 may include modifying the weights of one or more portions of the model second version according to the training loss function. For example, in some embodiments, training at block 210 may include modifying weights of the layer added at block 208. Additionally or alternatively, training at block 210 may include modifying weights of the original model portion, i.e., the layers or portions included in the model received at block 202. Accordingly, training at block 202 may teach the model to classify within the second type of information.

The method 200 may further include, at block 212, adding a further layer to the model second version to create a model third version. The added layer may be a classification layer added to the output of the model second version, for example. The further added layer may be a fully-connected layer, in some embodiments.

The method 200 may further include, at block 214, conducting second training on the machine learning model second version using a second type of information respective of the documents. The second type of information may be, for example, a second classification of the document or of the subject of the document, such as a taxonomy of a product that is the subject of the document. The training at block 214 may include classification training, in which a first type of information is provided to the model (e.g., document title), and the model predicts the classification within the third type of information. For example, the model may receive a product or other document title and may predict a taxonomy of the product (e.g., a classification within one or more layers of a multi-layer hierarchical taxonomy). The training at block 214 may enable the model to predict the classification of a document within the second type of information.

Training at block 214 may include modifying the weights of one or more portions of the model third version according to the training loss function. For example, in some embodiments, training at block 214 may include modifying weights of the further layer added at block 212. Additionally or alternatively, training at block 214 may include modifying weights of the original model portion, i.e., the layers or portions included in the model received at block 202. Accordingly, training at block 214 may teach the model to classify within the third type of information.

In some embodiments, the general process illustrated and described with respect to blocks 208, 210 or 212, 214—adding a layer to the model and then conducting additional training for an additional type of information—may be repeated to train the model to learn to classify within additional types of information. Such additional types of information may include, for example, image information, user sentiment information, and the like, but using such information types in the training data respective of a given training phase.

Although the method 200 has been described with reference to three rounds of training, fewer than three rounds of training, or more than three rounds of training, may be conducted, in some embodiments. Further, different rounds of training may use the same training data set as one or more other rounds (e.g., with a different objective for a particular round), or may use different training data sets than other rounds.

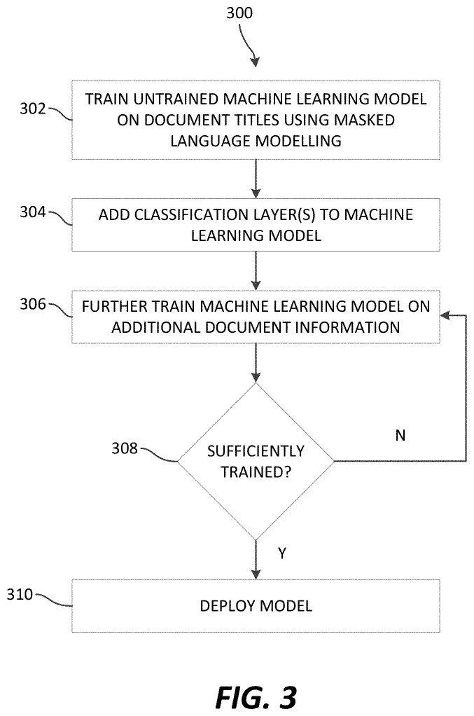

FIG. 3 is a flow chart illustrating an example method 200 of training and deploying a machine-learning model. One or more portions of the method 200 may be performed by the machine learning system 104, in some embodiments.

The method 300 may include, at block 302, training an untrained machine learning model on document titles using masked language modelling. The model may be, for example, a BERT model or another appropriate natural language processing model. In the masked language modelling training, the training data (e.g., document titles) are provided to the model with random tokens removed, and the model is tasked with predicting the removed token.

The method 300 may further include, at block 304, adding one or more classification layers to the machine learning model. The machine learning model trained in block 302 may output embeddings respective of the input tokens, and block 304 may include adding one or more classification layers that may be trained to classify those embeddings.

The method 300 may further include, at block 306, further training the machine learning model (including, in applicable embodiments, classification layer(s) added in block 304) using additional document information, such as taxonomy and brand information, for example.

The method 300 may further include, at block 308, determining whether or not the machine learning model is sufficiently trained. Block 308 may include, for example, comparing the prediction accuracy of the model to a threshold. If the model is not sufficiently trained, the method 300 returns to block 306.

If the model is sufficiently trained, the method 300 may advance to, at block 310, deploying the trained model. The model may be deployed, for example, to rank search engine results, in some embodiments. Additionally or alternatively, the machine learning model may be deployed to generate an image from the user query, which image may be compared to other images to provide search results. In such an embodiment, the model may include a natural language processing portion, such as BERT model, that generates embeddings from the tokens of the user text. A deconvolutional neural network may be trained to, and once trained may, generate an image based on those embeddings. That image may be compared to images associated with documents available through an electronic user interface (e.g., product images) according to known methods to provide search results based on image similarity.

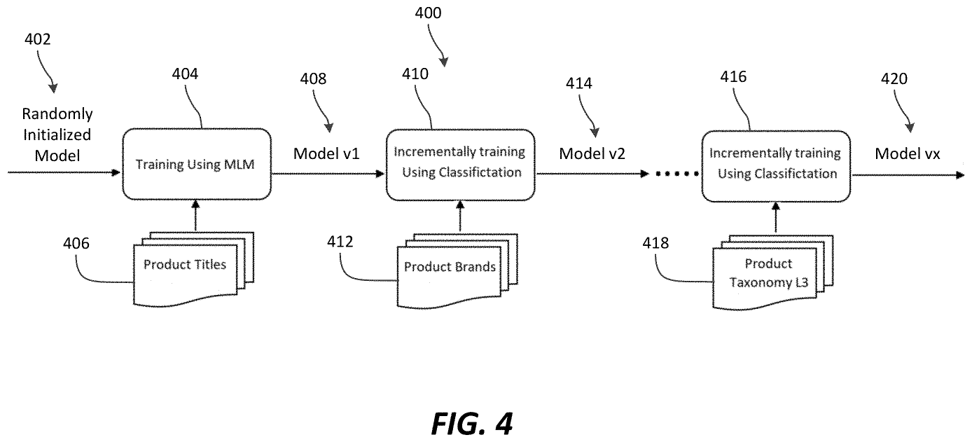

FIG. 4 is a block diagram 400 illustrating a particular embodiment of the method 300. As illustrated and as discussed above, a randomly-initialized model 402 may be received and trained at block 404 using first training data 406. Training at block 404 may include masked language modelling, which includes masking certain tokens in an input sentence and adjusting weights of the model to output the complete phrase. Further, as shown in FIG. 4, the first training data 406 may be or may include a set of product titles respective of a set of products available through a particular user interface, such as a particular website. Accordingly, training at block 404 may include training the model to recognize the vocabulary and phrases associated with the set of products.

After training at block 404, a classification layer may be added to the model 402 to create a new model version 408 (indicated in FIG. 4 as “Model v1”). The model version 408 may be trained at block 410 using second training data 412. Training at block 410 may include classification training, in which a first type of information is input to the model and the model outputs a second type of information (e.g., a predicted classification). For example, a set of product titles (e.g., the same product titles used at block 404) may be input for the machine learning model to predict a product brand, as indicated in FIG. 4 in the second training data 412. Training at block 410 may include modifying both the weights of the layer added to create model version 408 as well as the weights of the original portion of the model 402. The weights of the model version 408 may be modified according to a loss calculated using a loss function based on the output of the model version 408 during training. Accordingly, training at block 410 includes back-propagating the loss during training to the weights of the entire model, in some embodiments. As a result, the entire model (including the portions of the model present in model 402) may be trained to predict the information trained at block 410.

After training at block 410, a further classification layer may be added to the model 410 to create a new model version 414 (indicated in FIG. 4 as “Model v2”). The model version 414 may be trained at block 416 using third training data 418. Training at block 418 may include classification training, in which a first type of information is input to the model and the model outputs a second type of information (e.g., a predicted classification). For example, a set of product titles (e.g., the same product titles used at block 404) may be input for the machine learning model 414 to predict a product taxonomy (e.g., one or more levels of the taxonomy), as indicated in FIG. 4 in the third training data 418. Training at block 416 may include modifying both the weights of the layer added to create model version 414 as well as the weights of the original portion of the model 402. The weights of the model version 414 may be modified according to a loss calculated using a loss function based on the output of the model version 414 during training. Accordingly, training at block 416 includes back-propagating the loss during training to the weights of the entire model, in some embodiments. As a result, the entire model (including the portions of the model present in model 402) may be trained to predict the information trained at block 416.

In some embodiments, the operations described above with respect to model 414 and block 416 and training data 418 may be repeated through one or more iterations, with a classification layer added at each iteration and with different training data at each iteration, to train the model to classify different types of information. In some embodiments, the training data 406, 412, 418 used for training may all be associated with a single set of documents. For example, the documents may be product information pages associated with products and services available through a given electronic user interface (e.g., a given website). As a result, each set of training data 406, 412, 418 may be different from each other set at least with respect to the portions of the training data used to compare to the output of the model. The training data sets 406, 412, 418 may also partially overlap, such as with respect to the input data used in training (e.g., product titles in the example of FIG. 4). As a result, the model may be trained to predict multiple classifications based on a single input.

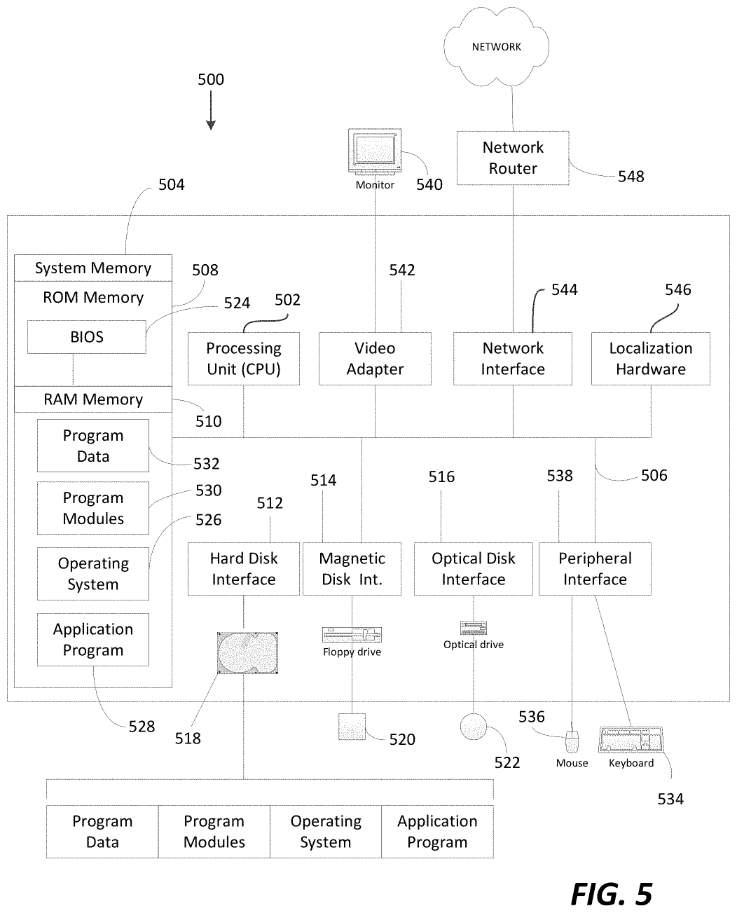

FIG. 5 is a diagrammatic view of an illustrative computing system that includes a computing system environment 500, such as a desktop computer, laptop, smartphone, tablet, or any other such device having the ability to execute instructions, such as those stored within a non-transient, computer-readable medium. Furthermore, while described and illustrated in the context of a single computing system 500, those skilled in the art will also appreciate that the various tasks described hereinafter may be practiced in a distributed environment having multiple computing systems 500 linked via a local or wide-area network in which the executable instructions may be associated with and/or executed by one or more of multiple computing systems 500. The computing system environment 500, or one or more portions of the computing system environment 500, may comprise the machine learning system 104 and/or the user computing device 106 of FIG. 1, in some embodiments.

Computing system environment 500 may include at least one processing unit 502 and at least one memory 504, which may be linked via a bus 506. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard drive 518, and/or peripheral memory devices may be used to store computer executable instructions comprising an operating system 526, one or more applications programs 528 (such as one or more applications that execute the methods and processes of this disclosure), other program modules 530, and/or program data 532. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus 506 via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 548, that is responsible for network routing. Communications with the network router 548 may be performed via a network interface component 544. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 546 for determining a location of the computing system environment 500. In embodiments, the localization hardware 546 may include, for example only, a GPS antenna, an RFID chip or reader, a WiFi antenna, or other computing hardware that may be used to capture or transmit signals that may be used to determine the location of the computing system environment 500.

In a first aspect of the present disclosure, a computing system for training a machine learning model is provided. The system includes a processor and a memory storing instructions that, when executed by the processor, cause the computing system to perform operations including receiving a first version of a machine learning model, conducting first training on the machine learning model first version, adding a layer to the machine learning model first version after conducting the first training to create a machine learning model second version, conducting second training on the machine learning model second version, and deploying the machine learning model after the second training.

In an embodiment of the first aspect, the machine learning model includes a plurality of multi-directional transformer encoders.

In an embodiment of the first aspect, the first training includes first training data and the second training includes second training data, wherein the first training data is different from the second training data. In a further embodiment of the first aspect, the first training data includes a first type of information respective of a plurality of entities and the second training data includes a second type of information respective of the plurality of entities.

In an embodiment of the first aspect, the layer comprises a fully-connected layer.

In an embodiment of the first aspect, the layer is a first layer, and the operations further include adding a second layer to the machine learning model second version to create a machine learning model third version and conducting third training on the machine learning model third version, wherein the deploying comprises deploying the machine learning model after the third training. In a further embodiment of the first aspect, the first training comprises first training data and the second training comprises second training data and the third training comprises third training data, wherein the first training data, the second training data, and the third training data are different from one another. In a further embodiment of the first aspect, the first training data includes a first type of information respective of a plurality of entities, the second training data includes a second type of information respective of the plurality of entities, and the third training data includes a third type of information respective of the plurality of entities.

In an embodiment of the first aspect, the first version of the machine learning model is randomly-initialized, deploying the machine learning model includes deploying the machine learning model in association with a plurality of documents, and the first training and the second training include use of training data selected from the plurality of documents.

In a second aspect of the present disclosure, a method is provided that includes receiving a first version of a machine learning model, conducting first training on the machine learning model first version, adding a layer to the machine learning model first version after conducting the first training to create a machine learning model second version, conducting second training on the machine learning model second version, and deploying the machine learning model after the second training.

In an embodiment of the second aspect, the machine learning model includes a plurality of multi-directional transformer encoders.

In an embodiment of the second aspect, the first training includes first training data and the second training includes second training data, wherein the first training data is different from the second training data. In a further embodiment of the second aspect, the first training data includes a first type of information respective of a plurality of entities and the second training data includes a second type of information respective of the plurality of entities.

In an embodiment of the second aspect, the layer comprises a fully-connected layer.

In an embodiment of the second aspect, the layer is a first layer and the method further includes adding a second layer to the machine learning model second version to create a machine learning model third version and conducting third training on the machine learning model third version, wherein the deploying includes deploying the machine learning model after the third training. In a further embodiment of the second aspect, the first training includes first training data and the second training includes second training data and the third training comprises third training data, wherein the first training data, the second training data, and the third training data are different from one another. In a further embodiment of the second aspect, the first training data includes a first type of information respective of a plurality of entities, the second training data includes a second type of information respective of the plurality of entities, and the third training data includes a third type of information respective of the plurality of entities.

In an embodiment of the second aspect, the first version of the machine learning model is randomly-initialized, deploying the machine learning model includes deploying the machine learning model in association with a plurality of documents, and the first training and the second training comprise use of training data selected from the plurality of documents.

In a third aspect of the present disclosure, a method is provided that includes receiving a randomly-initialized first version of a machine learning model, conducting first training on the machine learning model first version using first training data, the first training data including a first type of information respective of a plurality of documents, adding a layer to the machine learning model first version after conducting the first training to create a machine learning model second version, conducting second training on the machine learning model second version using second training data, the second training data including a second type of information respective of the plurality of documents, and deploying the machine learning model after the second training.

In an embodiment of the third aspect, the layer is a first layer and the method further includes adding a second layer to the machine learning model second version to create a machine learning model third version, conducting third training on the machine learning model third version using third training data, the third training data including a third type of information respective of the plurality of documents, wherein the deploying comprises deploying the machine learning model after the third training.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computing system for training a machine learning model, the system comprising:
a processor; and
a memory storing instructions that, when executed by the processor, cause the computing system to perform operations comprising:
receiving a first version of a machine learning model;
conducting first training on the machine learning model first version;
adding a layer to the machine learning model first version after conducting the first training to create a machine learning model second version;
conducting second training on the machine learning model second version; and
deploying the machine learning model after the second training.

2. The computing system of claim 1, wherein the machine learning model comprises a plurality of multi-directional transformer encoders.

3. The computing system of claim 1, wherein the first training comprises first training data and the second training comprises second training data, wherein the first training data is different from the second training data.

4. The computing system of claim 3, wherein the first training data comprises a first type of information respective of a plurality of entities and the second training data comprises a second type of information respective of the plurality of entities.

5. The computing system of claim 1, wherein the layer comprises a fully-connected layer.

6. The computing system of claim 1, wherein the layer is a first layer, wherein the operations further comprise:
adding a second layer to the machine learning model second version to create a machine learning model third version; and
conducting third training on the machine learning model third version;
wherein the deploying comprises deploying the machine learning model after the third training.

7. The computing system of claim 6, wherein the first training comprises first training data and the second training comprises second training data and the third training comprises third training data, wherein the first training data, the second training data, and the third training data are different from one another.

8. The computing system of claim 7, wherein:
the first training data comprises a first type of information respective of a plurality of entities;
the second training data comprises a second type of information respective of the plurality of entities; and
the third training data comprises a third type of information respective of the plurality of entities.

9. The computing system of claim 1, wherein:
the first version of the machine learning model is randomly-initialized; and
deploying the machine learning model comprises deploying the machine learning model in association with a plurality of documents; and
the first training and the second training comprise use of training data selected from the plurality of documents.

10. A method comprising:
receiving a first version of a machine learning model;
conducting first training on the machine learning model first version;
adding a layer to the machine learning model first version after conducting the first training to create a machine learning model second version;
conducting second training on the machine learning model second version; and
deploying the machine learning model after the second training.

11. The method system of claim 10, wherein the machine learning model comprises a plurality of multi-directional transformer encoders.

12. The method of claim 10, wherein the first training comprises first training data and the second training comprises second training data, wherein the first training data is different from the second training data.

13. The method of claim 12, wherein the first training data comprises a first type of information respective of a plurality of entities and the second training data comprises a second type of information respective of the plurality of entities.

14. The method of claim 10, wherein the layer comprises a fully-connected layer.

15. The method of claim 10, wherein the layer is a first layer, wherein the method further comprises:
adding a second layer to the machine learning model second version to create a machine learning model third version; and
conducting third training on the machine learning model third version;
wherein the deploying comprises deploying the machine learning model after the third training.

16. The method of claim 15, wherein the first training comprises first training data and the second training comprises second training data and the third training comprises third training data, wherein the first training data, the second training data, and the third training data are different from one another.

17. The method of claim 16, wherein:
the first training data comprises a first type of information respective of a plurality of entities;
the second training data comprises a second type of information respective of the plurality of entities; and
the third training data comprises a third type of information respective of the plurality of entities.

18. The method of claim 10, wherein:
the first version of the machine learning model is randomly-initialized; and
deploying the machine learning model comprises deploying the machine learning model in association with a plurality of documents; and
the first training and the second training comprise use of training data selected from the plurality of documents.

19. A method comprising:
receiving a randomly-initialized first version of a machine learning model;
conducting first training on the machine learning model first version using first training data, the first training data comprising a first type of information respective of a plurality of documents;
adding a layer to the machine learning model first version after conducting the first training to create a machine learning model second version;
conducting second training on the machine learning model second version using second training data, the second training data comprising a second type of information respective of the plurality of documents; and
deploying the machine learning model after the second training.

20. The method of claim 19, wherein the layer is a first layer, wherein the method further comprises:
adding a second layer to the machine learning model second version to create a machine learning model third version; and
conducting third training on the machine learning model third version using third training data, the third training data comprising a third type of information respective of the plurality of documents;
wherein the deploying comprises deploying the machine learning model after the third training.
